(19) United States
(12) Patent Application Publication
(10) Pub. No.: US 2004/0065833 A1
(43) Pub. Date: Apr. 8, 2004

(54) Method and apparatus for illuminating and collecting radiation

(76) Inventors: Ralph Torgrip, Violvagen (SE); Robert Tryzell, Huddinge (SE)

Correspondence Address: NIXON & VANDERHYE, PC, 1100 N GLEBE ROAD, 8TH FLOOR, ARLINGTON, VA, 22201-4714, US

(21) Appl. No.: 10/466,081

(22) PCT Filed: Jan. 11, 2002
(86) PCT No.: PCT/SE02/00040

(30) Foreign Application Priority Data
Jan. 11, 2001 (SE) 0100073-6

(51) Int. Cl. G01J 5/02

(52) U.S. Cl. 250/341.7

(57) ABSTRACT

A method and a device is disclosed for illuminating a sample (1) and/or reference and collecting diffuse reflected and/or transflected radiation from the illuminated element and delivering it to a measuring equipment. The illuminating means (2A to 2H), when illuminating a sample or a reference, provide an extending illumination, coming from at least two positions. A movable reflecting element (4) is provided such that it in one position reflects the light from the illuminating means (2A to 2H) onto the sample or reference to be irradiated and reflects the diffuse reflectance and/or transflectance from the sample or reference to means (3) collecting the radiation.

This invention relates substantially to a method for illuminating and collecting diffuse reflected and/or transflected radiation of the kind disclosed in the preamble of claim 1, and an apparatus for carrying the method into effect.

### BACKGROUND

The invention has been developed as an aid or support for non-invasive spectrophotometric measurements on pulp but it is by no means restricted to that particular area. Thus, radiation based measurements on several kinds of materials are to be supported with the invented method and apparatus.

The general worlding principle of spectrometers relies on illuminating a measuring test object, below called sample, or/and reference with some radiation and collecting the resulting radiation after illumination by some means. The incident light has then interacted with the radiated sample. The objective of the analysis is to derive one or more feature(s) of the test sample by analyzing the resulting radiation. The feature(s) can be, for example, concentration, turbidity, reflectance, color etc.

The resulting radiation from the sample is often normalized with the resulting radiation from a spectral reference. This normalization is done to cancel out any radiation path dependence or environmental disturbances on the system. A problem with prior systems has been to collect the radiation from the reference in the same way as the sample.

Radiating the sample can be done in different ways e.g. direct illumination with a radiation source, conveying radiation from the illuminating source to the measured object via some optics like mirrors, fiber optics etc.

The collection of the resulting radiation can also be done in several ways; the way this is performed is usually depending on the physical nature of the measured object and the nature of the illuminating radiation. The resulting radiation can be collected after the incident radiation has passed through the object to be measured i.e. the resulting radiation is collected in transmittance mode. The resulting radiation can also be collected as the reflected radiation from the sample; this measuring mode is called the reflectance measuring mode. There is also the possibility of putting a reflecting mirror behind the measured object and collect the radiation that has passed the measured object two (or more) times, also known as transflectance mode.

When measuring with radiation that does not penetrate the sample, either because the radiation is too weak or the sample is too thick to transmit the radiation one is left with the option of diffuse reflectance. Even so, in order to get enough radiation to the detector one puts the radiation source close to the measured object and conveys the resulting radiation to some detection device. This method yields enough radiation to be measured by a detector.

This kind of non-contact process analysis system operating with radiation in the visual-near infrared region of the electromagnetic spectrum is marketed for example by FOSS NIRSystems, which provides a direct-light sensor head which is mounted about 8 to 30 cm above a sample. Another manufacturer of a similar system is Brimrose.

Problems with existing single beam equipment are that they rely on one single radiation source and that the radiation paths differ between measurements of the sample and the spectral reference.

The effect of the problems is that when the radiation source is changed the resulting sample and/or reference spectrum changes for a given sample. The change depends on the fact that there are not two identical radiation sources. This is further complicated by the fact that the radiation paths for the incident radiation to the sample and to the reference are different. This makes the measurement sensitive to alignment differences in the radiation source.

The above-mentioned problems will have a negative effect on the property analysis. This analysis is often based on a mathematical model derived from a set of defined samples (calibration set) measured in the same way as future population of samples to be measured. Thus the mathematical model will not be valid after a change of radiation source and the system must be re-calibrated, a tedious and costly procedure. This is a problem for which the present invention will give a solution.

### THE INVENTION

An object of the invention is to provide a robust means for illuminating and collecting light for use in a non-invasive optical measurement system for measuring the optical features of at least one sample.

Another object of the invention is to provide a robust means for illuminating and collecting light for use in a non-invasive optical measurement system for measuring the optical features of at least one sample making use of at least one reference.

Yet another object of the invention is to provide a key component for an optical measurement system for measuring the optical features of at least one sample and having the means to adjust the system.

Yet another object of the invention is to provide a key component to measuring system for measuring the optical features of at least one sample and having means to adjust the system in a simple way.

The invention relates to a method and a device for illuminating a sample and/or reference and collecting diffuse reflected and/or transflected radiation from the illuminated element and delivering it to a measuring equipment. The invention is characterized in that the illuminating means, when illuminating a sample or a reference, provide an extending illumination, coming from at least two positions; and by providing a movable reflecting element such that it in one position reflects the light from the illuminating means onto the sample or reference to be irradiated and reflects the diffuse reflectance and/or transflectance from the sample or reference to means collecting the radiation. Each reference could be positioned and sized such that the movable reflecting means in another position than for the sample illuminates the reference in question in the same way as a sample regarding incident beam size and propagation path length, and pathway to the means collecting the radiation as if the reference were another sample.

The reflecting element is preferably provided as an inclined plane mirror rotatable around an axis being inclined to the mirror plane and provided in line with the means collecting the radiation. The plane of the reflecting element could be placed at an angle to the plane of the sample and to a plane through the illuminating means. The illuminating means could be placed around a line directed to the means collecting the radiation. The illuminating means could be provided as several radiation sources in at least one ring or other arrangement with symmetrical geometry around the line directed to the means collecting the radiation. Each of the samples and the references could be provided in a ring around the axis of the reflecting element, each sample and reference having an extension in a plane normal to a line from its central point and going through the rotational point of the inclined reflecting element.

At least one of the references could be used for a diagnostic purpose, for example to monitor the state of the instrument in order to have the opportunity to make adjustments, if something has gone out of order or need an adjustment. A ray dump could be provided as one empty member in the ring of sample(s) and reference(s) to make it possible to avoid to any degradation due to exposure without having to switch off the illumination means.

### BRIEF DESCRIPTION OF THE DRAWINGS

For a more complete understanding, of the present invention and for further objects and advantages thereof, reference is now made to the following description of examples of embodiments thereof—as shown in the accompanying drawings, in which:

FIG. 1 illustrates a perspective view of a preferred embodiment of an apparatus in accordance with the invention;

FIG. 2 shows a front view of the embodiment in FIG. 1;

FIG. 3 shows a side view of the same embodiment;

FIG. 4 shows a block schedule of an embodiment for controlling the apparatus for measuring diffuse reflectance; and

FIG. 5 shows a front view of a second embodiment of an apparatus in accordance with the invention.

### DETAILED DESCRIPTION OF A PREFERRED EMBODIMENTS

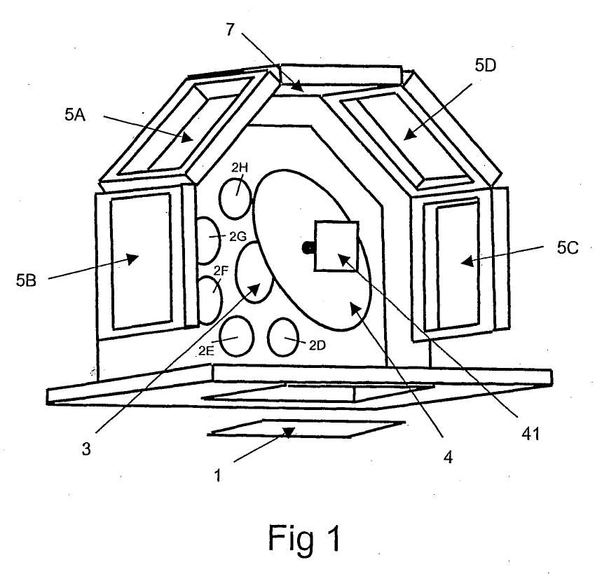

Referring to FIGS. 1 to 3, an arrangement for accurate diffuse reflectance and/or transflectance measurements is described.

The vital parts of the arrangement are the illumination system and the references. Some collecting optics and a detector are also needed.

A test object 1, below called sample, provided at a distance from the system is illuminated by one or several radiation sources 2A to 2H. The radiation source or sources are placed such that they give an extended illumination, i.e. the radiation is coming from at least two positions having a determined distance from each other. If only one radiation source is provided, then the radiation source itself is extended (not shown). If several radiation sources are provided, then they are provided at a fitting distance from each other.

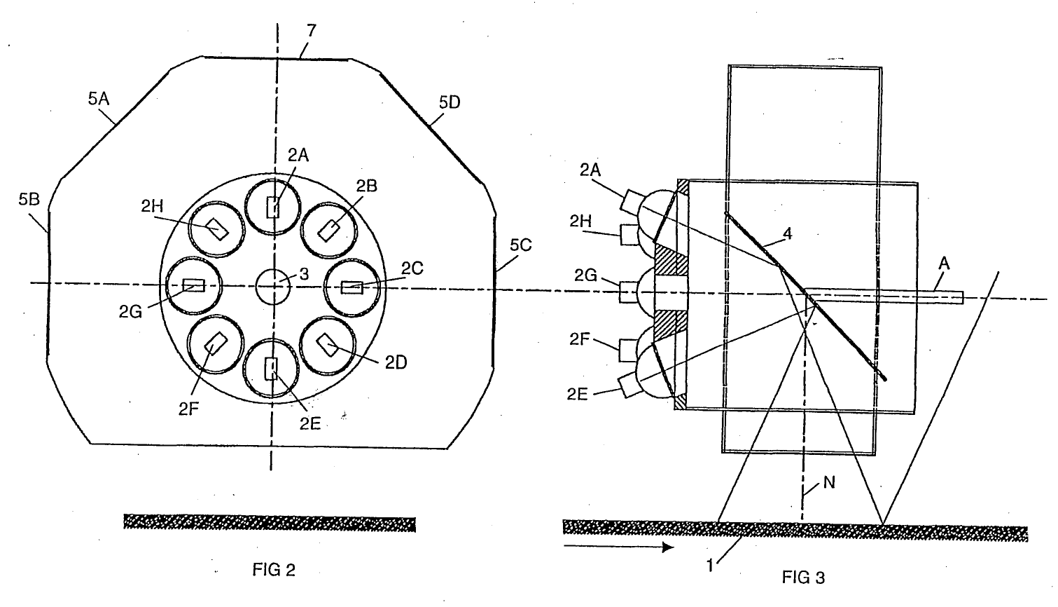

The radiation sources 2A to 2H can either be lasers, LEDs, black bodies, light sources, such as lamps, or any other radiation source. For the near infrared wavelength band for instance halogen lamps may be a good choice because of their small size and radiative efficiency in the near infrared wavelength band. As illustrated in FIG. 2 and 3, illustrated with lamps as the radiation sources, each lamp is provided with measures to diminish the divergence of the light beam. Each lamp is therefore illustrated to be surrounded by a dome-shaped mirror (reflector).

The radiation sources 2A-2H can all be alike. However, it is also possible to have different kinds of radiation sources evenly distributed among the other sources. They could arbitrarily be illuminated at different times or at the same times as the other radiation sources. The arrangement is such that the optical path from each radiation source to the sample 1 and from there to a detector unit 3 or a collecting optics for the detector is practically identical.

The system according to the invention could be a redundant system. Thus, all the radiation units 2A to 2H need not be used simultaneously. Different kinds of radiation sources could be provided, which could be controlled at different times. It is to be noted that the number of radiation sources could be rather large.

The angle of incidence from each radiation source 2A-2H at the test sample is the same. This angle can be chosen so that no specular (directly from the radiation sources via the mirror) reflection will reach the detector 3. The geometry is such that approximately all the radiation radiated from the radiation sources will be directed to the test sample. The radiation sources are preferably arranged in a circle around a projection of the normal to the sample 1. It is also possible to have more than one ring of radiation sources. With an arrangement like this all sources at the same radius from the normal are equivalent with respect to the sample 1. The detector 3 or the collecting optics for it is positioned at least near to the centre of the circle of radiation sources. Hereby cancelling differences between radiation sources.

For practical reasons, for example lifetime and service aspects, as well as system redundancy, it is possible to use a selection of the available radiation sources. This can be done almost without any loss of accuracy because any selection of a number of radiation sources can be considered as a good sampling of the actual type of sources.

A folding mirror 4 is positioned so as to conduct the light from the radiation sources 2A to 2H to the sample 1, i.e. having an angular position of 45° to a plane through the radiation sources. However, other angular positions are also possible. The mirror can be rotated stepwise to predetermined angular positions and back and forth. The rotation axis A of the mirror 4 is in line with the detector 3 or the collecting optics for it. The light reflected from the sample 1 is reflected by the mirror onto the detector 3 or the collecting optics. Thus, the invention supports the measurements of a sample in a measurement installment, such as a spectrophotometer, in order to provide the best condition precedent to provide the signal to the detector in as good quality as possible and also as reproducible as possible. Thus, the invention could be catergorized a Supportive Technology to see to it that the full potential of for example a spectrophotometer is used.

In order to get accurate results it is important to be able to calibrate the system against well-known references. Different references 5a to 5D may be needed to calibrate the system for signal amplitude and wavelength accuracy. In a specific test situation it is preferred that the references have similar optical characteristics as the sample 1.

Furthermore, it is important that references are positioned in the ray path in the same way as the sample. This can be arranged by placing the references 5A-5D and the sample 1 symmetrically around the rotary axis of the folding mirror 4. The position of each of the references in the ray path is provided by rotating the mirror to a predetermined position adapted to the reference in question. The mirror could be rotated around an axis provided in its centre and at an angle of, for example, 45° towards its surface. If other angles than 45° are used, then the sample 1 and the references should be inclined to a plane going through their centre points in an extent adapted to the angular position of the mirror 4.

The references are provided at such a distance from the radiation sources that it will be approximately the same distance for the light path from the radiation sources to the sample 1 as to each one of the references. The beam geometry will also be the same. When the mirror is turned the light path will not be directed to the sample 1 but to one of the references instead. It is then the reflection from that reference that is reflected onto the detector 3 by the mirror 4 in the same way as the reflection from the sample 1. Thus, the irradiations of the sample 1 and of each one of the references to be used are not made simultaneously but in consecutive steps.

Each of the samples and the references are thus placed in a ring or other arrangement with symmetric geometry around the mirror axis, each sample and reference having its central point in a plane going through the central point of the inclined mirror. Each of the samples and the references are extended normal to a line between its central point and the central point of the inclined mirror.

It is to be noted that another sample could be provided instead of one of the references 5A to 5D. The samples and the references are provided as elements in the sides of a polygonal ring-formed drum. Therefore, each element in each side of this polygonal drum could arbitrarily be inserted as a sample or as a reference. Each sample and reference has then its central point in a plane going through the central point of the inclined mirror.

Suitably, each measurement on a sample is followed by one measurement on one of the references. Several measurements on references could of course be done.

The references could be used for different purposes. Two purposes are to calibrate the system for wavelength and radio(photo)metric accuracy. Typically, when calibrating the system for wavelength accuracy, a reference with defined peak locations is measured. The resulting peak location can then be compared to the defined peak location, and a correction can be made. Likewise, for calibrating the radio(photo)metric accuracy, preferably, a reference with defined reflectance is measured. The resulting signal is compared to the defined level of reflectance, and a correction can be made. Thus, different references could be used for different diagnostic purposes, for example to monitor the state of the instrument in order to have the opportunity to make adjustments.

Optimally, there will be at least one reference, which is similar to the sample to be measured, since, usually, the resulting signal from the sample is subtracted with the reference signal. Ideally, one prefers a reference that is similar in signal response to the sample measured.

The folding mirror 4 can be turned stepwise by a motor 41 to reflect light to and from a reference or a sample in any preferred order. In fact the reference for example 5A and sample 1 become totally interchangeable. It is also to be noted that the ring of radiation sources 2A to 2H need not be stationary, but could be rotatable such that the radiation sources follow the movement of the mirror 4. This could be done with a motor having a ganged movement with the motor 41. This will make the illumination pathway of the sample and reference even more like each other.

One position around the rotating mirror 4 can also be configured as a ray dump. Thus, instead of a reference element an empty glass 7 or nothing is provided at that position. The references 5A to 5D and the sample 1 may be sensitive to long-term exposure to light or thermal radiation. The ray dump 7 makes it possible to avoid any degradation due to radiation exposure without having to switch off the radiation sources. A reason for not turning off the radiation sources is that it takes a certain time to achieve a steady state, which may be necessary for the repeatability of the measurements, especially if continuous measurements should be taken on a moving object.

The diffusely reflected light from the samples and/or the references is directed towards the detector 3 preferably by collecting optics. The collecting optics can comprise lenses, mirrors, fibre optics, or combinations thereof. The collecting optics is placed symmetrically in respect to the radiation sources preferably on the normal N to the sample 1.

The detector 3 can comprise any kind of optical sensors, sensing the wanted wavelength region or regions to be analysed. In many cases when spectrally resolved measurements are wanted it is necessary to use a spectrophotometer.

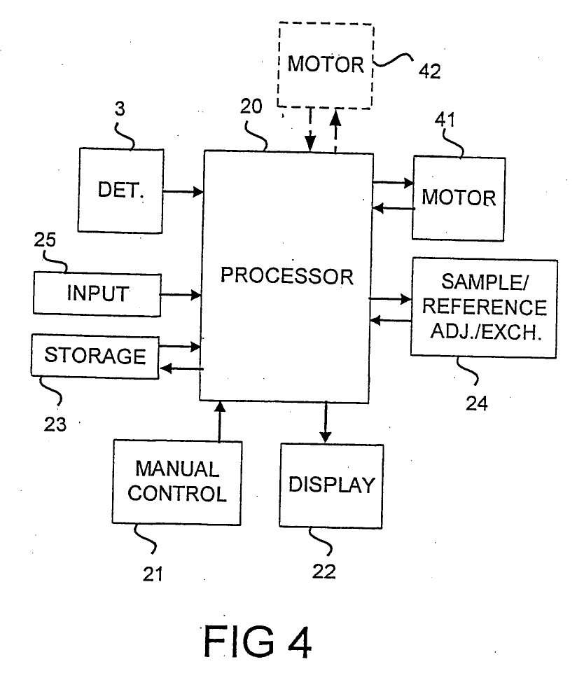

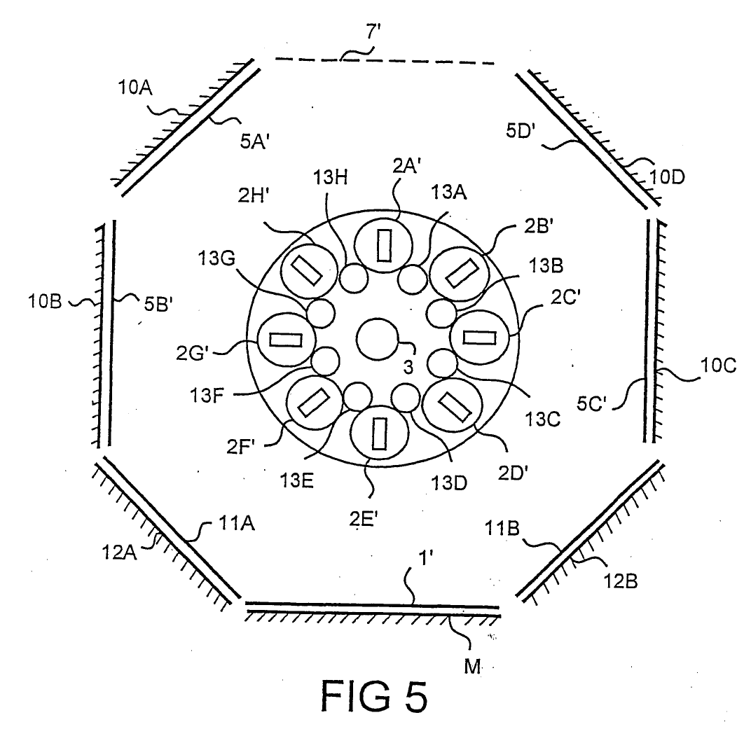

Referring to FIG. 4, in which the electronic circuitry to monitor and control the device comprises a processing means 20, to which the analogue/digital-converted signal from the detector unit 3 is connected. A manual control 21, such as a keyboard, a display 22, and a storage 23 are also connected to the processor 20. An input 25 is provided, through which different kinds of programs for making different kinds of measurement procedures could be inserted. The processor 20 is also connected to control the step motor 41 and receives a digital information of the angular position of the motor 41 from position sensors (not shown). If the radiation sources 2A to 2H are to be rotated the processor 20 also controls a motor 42 rotating the radiation sources in ganged rotation with the rotating of the motor 41.

In some applications it could be possible to make automatic changes of references and/or samples by a reference/sample changing or adjusting unit 24. The unit 24 could also indicate to the processor 20 if a reference or a sample needs adjustment of some kind.

An operator of the system could thus input an application making a predetermined measurement sequence, which could be cyclically repeated, particularly if a measurement is provided on a moving sample. For example making spectral-photo-metric measurements on a moving band comprising pulp. The processor 20 could then in a sequence rotate the motor 41 to measure a sample, then rotate the mirror 4 for a measurement of a reference, then change the illumination and rotate the mirror 4 to make a new measure of the sample, rotate the mirror 4 for a measurement of another of the references, etc. The result of the measurements could be displayed in real time on the display 22.

The processor 20 could as a complement make certain programmed calculations, and show these to the operator. The operator could also control the system manually or partly automatically via the manual control to make some extra measurements of for example a certain reference to check if the system is working correctly. The operator could also chose between different kinds of sequence proceedings for examples shown on a menu on the display by operating the keyboard.

An embodiment illustrating transflectance is shown in FIG. 5. This embodiment has the same view as FIG. 2. The elements having the same features and places as the ones in FIG. 2 have the same references but are shown with an “′”. In this embodiment a reflector, such as a mirror M, is placed behind the sample 1′, which is partly transparent. Thus, the beam path from the radiation sources 2A′ to 2H′ will be reflected by the rotatable reflector or mirror 4 (not shown in FIG. 5), go through the sample 1′, be reflected by the reflector M, go through the sample 1′ again, and then be reflected by the reflector 4 towards the detecting unit 3. A reflector or a mirror 10A to 10D is placed behind each reference 5A′ to 5D′. Each reference is then partly transparent. The beam path will then for each reference be the same as for the beam path described above for the sample 1′.

The embodiment in FIG. 5 also illustrates that there can be more than one sample, i.e. 11A and 11B. Since this embodiment illustrates transflectance a reflector or a mirror 12A and 12B is placed behind each sample 11A and 11B, respectively.

FIG. 5 also illustrates that there could be more than one ring of radiation sources, i.e. the sources 13A to 13H, and that the rings could comprise different kinds of radiation sources. The ring 2A′ to 2H′ could for example comprise lamp bulbs and the ring 13A to 13H′ lasers. The different kinds of radiation sources could be chosen such that the samples and references will be opaque when illuminated with one kind of radiation sources, and hence be working in a reflectance mode, and partly transparent when illuminated with another kind of radiation sources, and then be working in the transflectance mode. There could be more than two rings of radiation sources.

All through the invention is described with respect to a suggested embodiment it should be understood that modifications can be made without departing from the scope thereof. Accordingly, the invention should not be considered to be limited to the described embodiments, but defined only by the following claims, which are intended to embrace all equivalents thereof.

We claim

1. A method for illuminating a sample (1) and/or reference and collecting diffuse reflected and/or transflected radiation from the illuminated element and delivering it to a measuring equipment,
characterized in that the illuminating means (2A to 2H), when illuminating a sample or a reference, provide an extending illumination, coming from at least two positions; and by
providing a movable reflecting element (4) such that it in one position reflects the light from the illuminating means (2A to 2H) onto the sample or reference to be irradiated and reflects the diffuse reflectance and/or transflectance from the sample or reference to means (3) collecting the radiation.

2. A method according to claim 1 comprising at least one reference (5A to 5D), characterized by positioning and sizing each reference (5A to 5D) such that the movable reflecting means (4) in another position than for the sample illuminates the reference in question in the same way regarding incident beam size and propagation path length, and pathway to the means (3) collecting the radiation as if the reference were another sample (1).

3. A method according to claim 1 or 2, characterized by providing the reflecting element as an inclined plane mirror (4) rotatable around an axis being inclined to the mirror plane and provided in line with the means (3) collecting the radiation.

4. A method according to claim 1 or 2, characterized by placing the plane of the reflecting element at an angle to the plane of the sample and to a plane through the illuminating means (2A to 2H; 2A′ to 2H′, 13A′ to 13H′).

5. A method according to anyone of the preceding claims, characterized by providing the illuminating means (2A to 2H; 2A′ to 2H′, 13A′ to 13H′) around a line directed to the means (3) collecting the radiation.

6. A method according to claim 5, characterized by providing the illuminating means as several radiation sources (2A to 2H; 2A′ to 2H′, 13A′ to 13H′) in at least one ring or other arrangement with symmetrical geometry around the line directed to the means (3) collecting the radiation.

7. A method according to anyone of the preceding claims, characterized by placing each of the samples (1; 1′, 11A, 11B) and the references (5A to 5H; 5A′ to 5H′) in a ring around the axis of the reflecting element, each sample and reference having an extension in a plane normal to a line from its central point and going through the rotational point of the inclined reflecting element (4).

8. A method according to anyone of the preceding claims, characterized by using at least one of the references for a diagnostic purpose, for example to monitor the state of the instrument in order to have the opportunity to make adjustments, if something has gone out of order or need an adjustment.

9. A method according to anyone of the preceding claims, characterized by providing a ray dump (7; 7′) as one empty member in the ring of sample(s) and reference(s) to make it possible to avoid to any degradation due to exposure without having to switch off the illumination means.

10. A method according to anyone of the preceding claims, characterized by rotating the illuminating means (2A to 2H; 2A′ to 2H′, 13A to 13H) in a ganged movement with the reflecting element (4), such that the radiation from the illuminating means follows the movement of the reflecting element (4).

11. A device for illuminating a sample (1) and/or reference and collecting diffuse reflected and/or transflected radiation from the illuminated element and delivering it to a measuring equipment comprising means (3) collecting the radiation and illuminating means,
characterized in that illuminating means (2A to 2H), when illuminating a sample, have an extending illumination, coming from at least two positions; and by
a movable reflecting element (4) provided such that it in one position reflects the light from the illuminating means (2A to 2H) onto one of the samples to be illuminated and reflects the diffuse reflectance and/or transflectance from the sample to the means (3) collecting the radiation.

12. A device according to claim 11 comprising at least one reference (5A to 5D), characterized in that each reference (5A to 5D) is positioned and sized such that the movable reflecting means (4) in another position illuminates the reference in question in the same way regarding incident beam size and propagation path length, and pathway to the means collecting the radiation as if the reference were another sample (1).

13. A device according to claim 12, characterized in that the reflecting element is an inclined plane mirror (4) rotatable around an axis (A), which is inclined to the mirror plane and provided in line with the means (3) collecting the radiation.

14. A device according to anyone of the claims 11 to 13, characterized in that the plane of the mirror is positioned at an angle to the plane of the sample and to a plane through the illuminating means (2A to 2H).

15. A device according to anyone of the claims 11 to 14, characterized in that the illuminating means (2A to 2H) are placed around a line directed to the means (3) collecting the radiation.

16. A device according to claim 15, characterized by several radiation sources (2A to 2H, 13A to 13H) provided as the illuminating means in a ring around the line directed to the means (3) collecting the radiation.

17. A device according to anyone of the claims 11 to 16, characterized in that each of the samples (1; 1′) and the references (5A to 5H; 5A′ to 5H′, 13A to 13H) are placed in at least one ring around the axis (A) of the reflecting element, each sample and reference having an extension in a plane normal to a line from its central point and going through the central point of the inclined reflecting element (4).

18. A device according to anyone of the claims 11 to 17, characterized in that at least one of the references is adapted for some diagnostic purpose, for example to monitor the state of the instrument in order to have the opportunity to make adjustments, if something has gone out of order or need an adjustment.

19. A device according to anyone of the claims 11 to 18, characterized by a ray dump (7, 7′) provided as an empty member in the ring of sample(s) and reference(s) to make it possible to avoid any degradation due to exposure without having to switch off the illumination means.

20. A device according to anyone of the claims 11 to 19, characterized by a motor (42) for rotating the illuminating means (2A to 2H; 2A′ to 2H′, 13A to 13H) having a ganged movement with the motor (41) rotating the mirror (4), such that the radiation from the illuminating means follows the movement of the mirror (4).
